(19) United States
(12) Patent Application Publication
(10) Pub. No.: US 2016/0258148 A1
(43) Pub. Date: Sep. 8, 2016

(54) Pipe Cleaning Hose Attachment

(71) Applicant: Adam Pant, Six Lakes, MI (US)

(72) Inventor: Adam Pant, Six Lakes, MI (US)

(21) Appl. No.: 14/944,521

(22) Filed: Nov. 18, 2015

Related U.S. Application Data
(60) Provisional application No. 62/126,786, filed on Mar. 2, 2015.

(51) Int. Cl. E03C 1/306; B08B 9/032

(52) U.S. Cl. CPC E03C 1/306; B08B 9/0321

(57) ABSTRACT

A pipe cleaning device. The pipe cleaning device includes a connector, a body, and a cleaning head each having an interior channel therethough. The connector is removably attachable to a water supply hose, such as a garden hose. The cleaning head includes a central aperture and one or more radial apertures wherein the apertures have a diameter less than the diameter of the interior channel. In use, the connector is connected to a water supply hose and the cleaning head is inserted into a clogged or otherwise blocked drain. Water flows through the interior channel via the water supply hose and is expelled from the apertures. The smaller diameter of the apertures relative to the interior channel diameter causes water to be expelled from the apertures at a high velocity, which in turn removes debris or blockages from the pipe.

### CROSS REFERENCE TO RELATED APPLICATIONS

This application claims the benefit of U.S. Provisional Application No. 62/126,786 filed on Mar. 2, 2015. The above identified patent application is herein incorporated by reference in its entirety to provide continuity of disclosure.

### FIELD OF THE INVENTION

The present invention relates to devices for cleaning the interior of pipes. More particularly, the present invention relates to pipe cleaning devices that are connectable to an external water supply via a hose.

### BACKGROUND OF THE INVENTION

Pipes such as drain pipes, waste pipes, and the like that typically transport water or other liquids in combination with solids are susceptible to clogging or becoming blocked by debris, preventing water or other material from flowing therethrough. One typical way of removing a blockage from a pipe is to utilize a pipe snake, which consists of a spring-like device typically made from metal that is insertable into a pipe. The pipe snake is then moved back and forth within the pipe in order to remove debris from the pipe interior. One drawback of using a traditional pipe snake is that debris and blockages are often too difficult to remove via the application of mechanical force alone, requiring additional tools to complete the task. Another drawback to using a pipe snake to clean a pipe is that the interior walls of the pipe are subject to abuse and possible corrosion due to continuous contact with the pipe snake. Therefore, it is desirable to provide a pipe cleaning device that does not require contact with the interior of the pipe to be cleaned.

Another common way of cleaning a blocked pipe is to use chemicals such as household pipe or drain cleaner. These chemicals are typically caustic and as such break down the blockage in a pipe when in contact therewith. The caustic chemicals often erode the interior surface of a pipe over time, which potentially damages its structural integrity. Using pipe cleaning chemicals is also undesirable because they can cause injury to a user via contact with the user's skin. Residual chemicals sometime remain in the pipe even after a blockage has been removed. The residual chemicals can then contaminate the liquid that flows through the pipe during normal use. It is therefore desirable to provide a pipe cleaning device capable of cleaning the interior of a pipe without the use of harmful chemicals.

The present invention provides a new and improved pipe cleaning device that utilizes pressurized water to remove debris and blockages from the interior of a pipe. The pipe cleaning device serves as an improvement over prior art devices and methods in that it provides a process for removing blockages and debris from pipes that does not include caustic chemicals. It further provides a process for removing blockages without needed to scrape the interior surface of the pipe with a tool to remove the debris thereon. The present invention may be connected to a garden hose as a means of supplying water to the device, so it may be utilized by any consumer having a garden hose on their property.

### SUMMARY OF THE INVENTION

In view of the foregoing disadvantages inherent in the known types of pipe cleaning devices now present in the prior art, the present invention provides a pipe cleaning hose attachment wherein the same can be utilized for providing convenience for the user when cleaning the interior of a pipe. The present system comprises a pipe cleaning device attachable to a hose that is itself connected to an external water supply such as a garden hose.

It is therefore an object of the present invention to provide a novel and improved pipe cleaning device having all of the advantages of the prior art and none of the disadvantages.

Another object of the present invention is to provide a pipe cleaning device configured to remove debris and blockages from pipes by utilizing a plurality of high velocity water streams.

A further object of the present invention is to provide a pipe cleaning device consisting of a connector connectable to an external water supply hose such as a garden hose and attached to a body at another end, and a cleaning head attached to an opposite end of the body.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a pipe cleaning device according to the present invention.

FIG. 2 shows an exploded view of a pipe cleaning device according to the present invention.

FIG. 3 shows a side perspective view of the cleaning head portion of a pipe cleaning device according to the present invention.

FIG. 4 shows a front perspective view of the cleaning head portion of a pipe cleaning device according to the present invention.

FIG. 5 shows a cross-sectional view of a pipe cleaning device according to the present invention being used to clean a pipe.

### DETAILED DESCRIPTION OF THE INVENTION

Reference is made herein to the attached drawings. Like reference numerals are used throughout the drawings to depict like or similar elements of the pipe cleaning device. For the purposes of presenting a brief and clear description of the present invention, the preferred embodiment will be discussed as used for cleaning the interior surface of a pipe. The figures are intended for representative purposes only and should not be considered to be limiting in any respect.

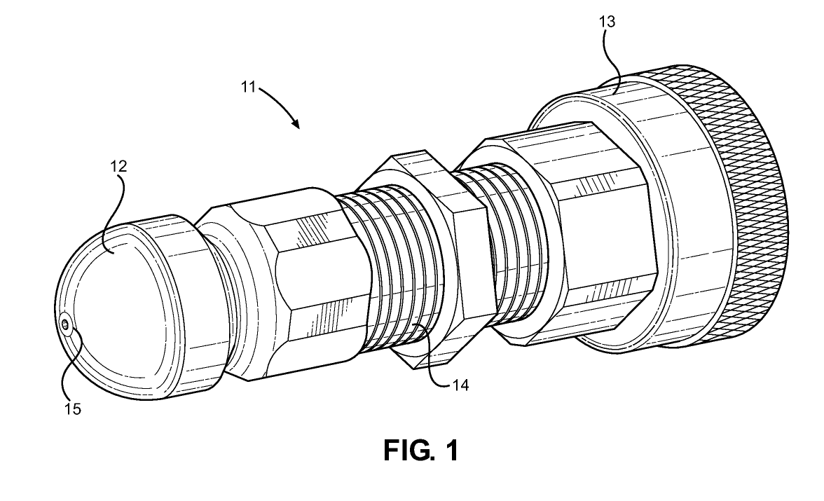

Referring now to FIG. 1, there is shown a perspective view of a pipe cleaning device according to the present invention. The present invention provides a pipe cleaning device 11 having a cleaning head 12 configured to expel pressurized water therefrom in order to clean the interior of a pipe. A hose, such as a garden hose, can be affixed to the pipe cleaning device 11. The cleaning head is insertable into a pipe and is configured to remove debris and blockages from the interior of the pipe via water expelled from the cleaning head 12.

The pipe cleaning device 11 further comprises a connector 13 attached to a body 14, which is attached to the cleaning head 12. Each of the connector 13, body 14, and cleaning head 12 have a continuous interior channel disposed therethrough. The connector 13 is removably attachable to a hose configured to supply water, which may be a garden hose or other type of hose adapted to transport liquid material therethrough. In one embodiment of the invention, the connector 13 comprises threading disposed on an inner surface thereof to engage the complementary threading of a water source, such as a garden hose. The connector 13 can also be removably attachable to the body 14 via a threaded connection in order to accommodate various types and sizes of connectors 13. The size of the connector 13 may vary in order to accommodate water supply hoses having different diameters.

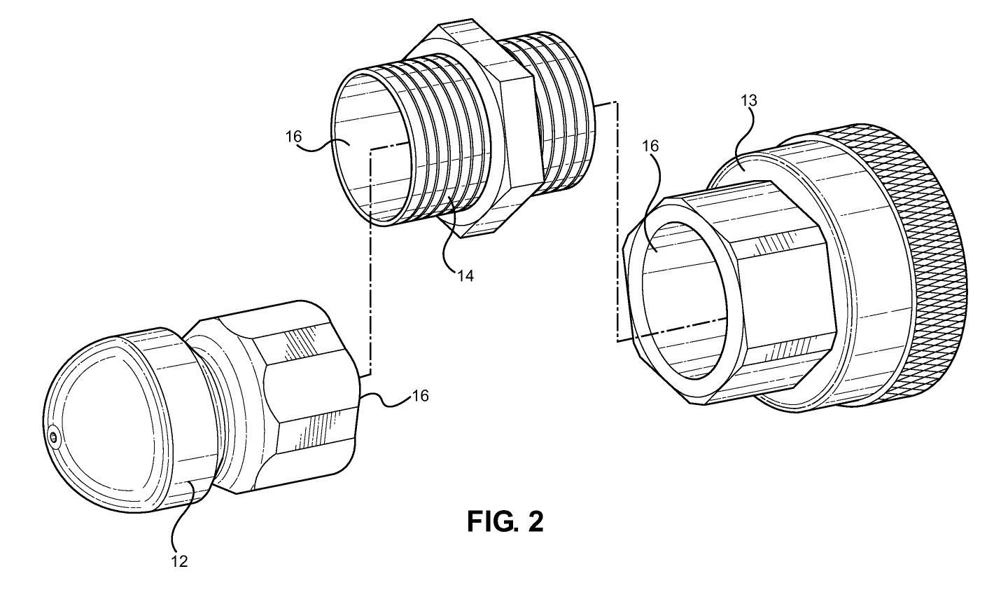

Referring now to FIG. 2, there is shown an exploded view of a pipe cleaning device according to the present invention. In one embodiment of the invention, the cleaning head 12 is removably attached to the body 14 via a threaded connection. In this way, different sized cleanings heads 12 may be utilized for pipes having different diameters. Each of the connector 13, body 14, and cleaning head 12 has an interior channel 16 through which water may flow. When the connector 13, body 14, and cleaning head 12 are affixed together, the interior channels 16 thereof are aligned, defining a continuous channel extending through the length of the components.

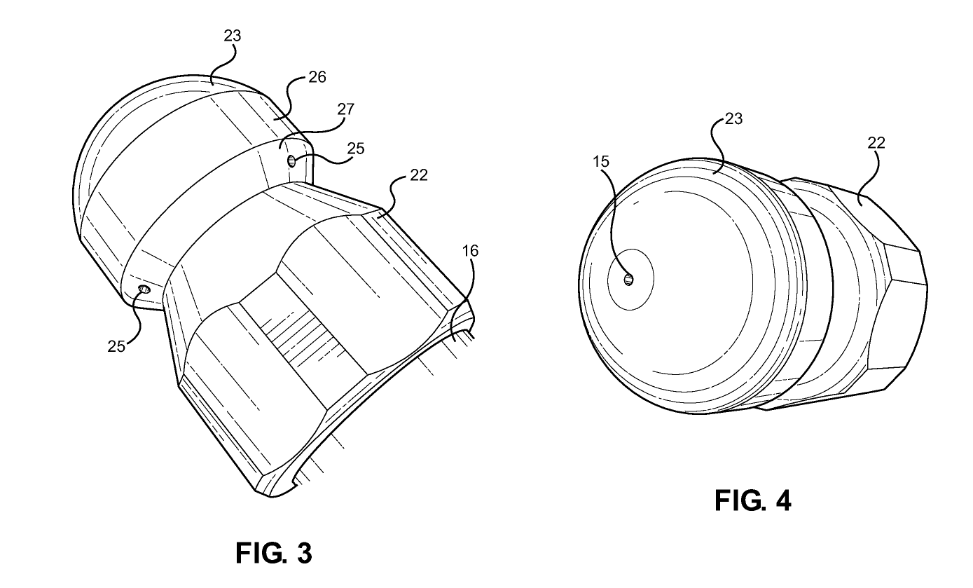

Referring now to FIGS. 3 and 4, perspective views of a cleaning head portion of a pipe cleaning device according to the present invention are shown. The cleaning head 12 comprises a base portion 22 and a top portion 23. The base portion 22 is connectable to a first end of the body 14. The top portion 23 of the cleaning head 12 comprises a central aperture 15 in fluid communication with the interior channel 16. The central aperture 15 has a diameter that is narrower than the diameter of the interior channel 16 disposed through the connector 13, the body 14, and the cleaning head 12. The narrower diameter of the central aperture 15 causes the water pressure to increase at the central aperture 15 of the cleaning head 12, allowing for water to be expelled therefrom at high velocities. The water expelled therefrom is traveling at such velocities that dirt and debris are removed from the interior surface of a pipe.

The top portion 23 of the cleaning head 14 further comprises a shoulder 26. The shoulder 26 is disposed around the outer perimeter of the cleaning head 23. A lower portion 27 of the shoulder 26 tapers inwardly toward the base portion 22 of the cleaning head 14. The shoulder 26 further comprises one or more of radial apertures 25 disposed on the lower portion 27 of the shoulder 26. The radial apertures 25 are in fluid communication with the interior channel 16 of the head 12. The radial apertures 25 are disposed around a perimeter of the lower portion 27 of the shoulder 26.

In use, the radial apertures 25 expel water therefrom in the same manner as the central aperture 15. The radial apertures 25 are angled toward the body 14 of the pipe cleaning device. The water expelled from the radial apertures 25 is directed backwardly compared to the water expelled from the central aperture 15. In this way, the pipe cleaning device 11 may expel water in a radial fashion with respect to the pipe interior wall, allowing the device to clean the entirety of the pipe interior surface in addition to removing solid blockages.

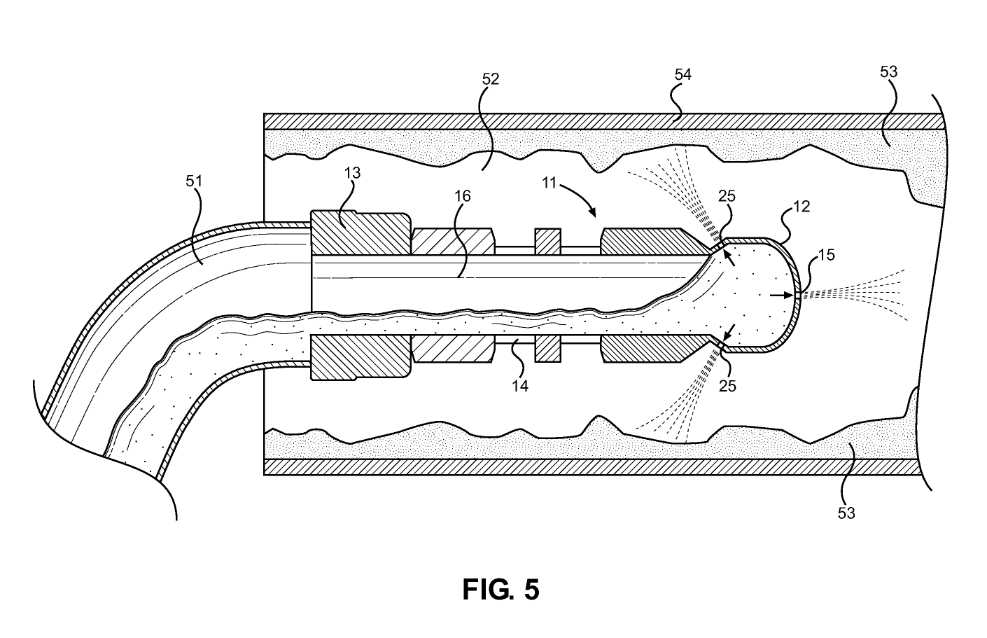

Referring now to FIG. 5, a perspective view of a pipe cleaning device according to the present invention is shown in use. In order to the use the pipe cleaning device 11, the user first attaches the connector 13 to a hose that is itself connected to a water supply, such as a garden hose 51. The user then inserts the device into the particular pipe 52 to be cleaned. Water flows through the interior channel 16 disposed throughout the length of the pipe cleaning device 11 and is expelled from the central aperture 15 and the radial apertures 25. Because the diameter of the apertures 15, 25 is substantially less than the diameter of the interior channel 16, the water pressure increases at the central aperture 15 and radial apertures 25, which in turn provides a high velocity expulsion of water from therefrom. The water then cleans built up debris and other blockages 53 from the pipe interior. The radial apertures 25 particularly clean the interior walls 54 of the pipe 52 while the central aperture 15 particularly removes debris blocking the center portion of the pipe 52.

It is also contemplated that the pipe cleaning device 11 may be used for the purpose of thawing frozen pipes. A user may insert the pipe cleaning device 11 into a pipe 52 having a partially frozen blockage 53 that blocks part or all of the flow through the pipe. The pipe cleaning device may then be used to spray warm water at the frozen blockage, causing the frozen portion 53 of the pipe 52 to thaw, allowing material to flow therethrough.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pipe cleaning device comprising:
a connector having a first end and a second end, the first end connectable to a hose;
a body connectable to the second end;
a cleaning head connectable to the body, the cleaning head having a central aperture configured to direct a liquid in a forward direction and one or more radial apertures configured to direct the liquid in a backward direction;
wherein the connector, the body, and the cleaning head are in fluid communication when connected, forming a channel therethrough;
wherein a diameter of each of the central aperture and the one or more radial apertures is less than an interior diameter of the channel;
and wherein each of the central aperture and the one or more radial apertures is in fluid communication with the channel.

2) The pipe cleaning device of claim 1, wherein the cleaning head comprises a top portion attached to a base portion, the base portion having peripheral edges tapering inwardly toward the top portion, the top portion comprising a central aperture having a diameter, the central aperture in fluid communication with the channel.

3) The pipe cleaning device of claim 2, wherein the top portion of the cleaning head further comprises a shoulder having a lower portion, the lower portion of the shoulder tapering inwardly toward the base portion of the cleaning head, the shoulder comprising one or more radial apertures each having a diameter disposed on the lower portion of the shoulder, the one or more radial apertures in fluid communication with the channel.

4) The pipe cleaning device of claim 3, wherein the connector comprises a cylinder having a circumferential sidewall, the circumferential sidewall having an inner edge and an outer edge.

5) The pipe cleaning device of claim 4, wherein the connector further comprises an O-ring disposed within the channel of the connector.

6) The pipe cleaning device of claim 5, wherein the O-ring is contiguous with the inner edge of the connector.

7) The pipe cleaning device of claim 1, wherein the cleaning head is removably attached to the body.

8) The pipe cleaning device of claim 1, wherein the connector is removably attached to the body.

9) The pipe cleaning device of claim 1, wherein the top portion of the cleaning head is hemispherical.

10) The pipe cleaning device of claim 3, wherein each of the one or more of radial apertures of the shoulder are angled toward the connector.

11) The pipe cleaning device of claim 3, wherein each of the one or more radial apertures of the shoulder are angled outward from the channel.

12) The pipe cleaning device of claim 6, wherein the inner edge comprises a plurality of threads disposed thereon.

13) The pipe cleaning device of claim 12, wherein the connector is adapted to receive a garden hose and removably attach thereto via the plurality of threads.
